(19) United States
(12) Patent Application Publication
(10) Pub. No.: US 2002/0051415 A1
(43) Pub. Date: May 2, 2002

(54) Recording waveform generator and disk recording device

(75) Inventor: Yukio Iijima, Nara (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 09/983,929

(22) Filed: Oct. 26, 2001

(30) Foreign Application Priority Data
Oct. 26, 2000 (JP) 2000-326588

(51) Int. Cl. G11B 7/005

(52) U.S. Cl. 369/59.2

(57) ABSTRACT

A recording waveform generation circuits processes a data signal in synchronization with a prescribed delay clock signal selectively output from a selector in order to generate a recording waveform signal. A selection control section controls selection operation of the selector not only when a record/non-record signal indicates a non-recording state, but also when the record/non-record signal indicates a data recording state as well as a mark space circuit detects a space period.

### BACKGROUND OF THE INVENTION

The present invention generally relates to a disk recording device. More particularly, the present invention relates to technology enabling data to be continuously recorded for a long time in a stable manner.

With recent increase in performance of the electronic equipments, the data amount for use in image display and the like is increased, and recording capacity of a recording media for storing the data has been strongly demanded. Recently, an optical disk device capable of random access and having a large capacity has attracted attention as such a recording media.

As shown in FIG. 4A, in the optical disk device, when laser beams are continuously radiated during a period in which a recording mark is formed, radiation heat of the laser beams is accumulated at the disk surface, whereby the recording mark gradually grows into a teardrop shape. If the data continues to be recorded, the data cannot be properly reproduced. Accordingly, in an actual optical disk device, a recording waveform signal is corrected during a data-recording period in order to prevent such a physical phenomenon. For example, as shown in FIG. 4B, laser beams that are recorded on the optical disk are frequently turned ON/OFF. Such operation is referred to as record compensation operation. Note that characteristics of the disk vary depending on a disk material. Therefore, for example, DVD-R (Digital Versatile Disk-Recordable) and DVD-RAM (Digital Versatile Disk-Random Access Memory) have different record pulses.

FIG. 5 is a block diagram of a conventional optical disk device, in particular, circuitry for generating a recording waveform signal. In order to implement the above record compensation operation, a recording waveform generating section 50 delays a clock signal SCK1 so as to optimize the phase thereof, and processes a data signal DATA in synchronization with a clock signal SCK2i having an optimized phase, thereby generating a recording waveform signal SWF. A signal SDL indicates a delay time by which the clock signal SCK1 is to be delayed, and a signal SST indicates whether the data signal DATA is to be recorded on the optical disk or not.

Operation of the conventional optical disk device shown in FIG. 5 will be described in connection with FIG. 6.

Time T0 is an initial state. At time T0, data to be recorded has not been recorded as a data signal DATA, and a record/non-record signal SST is at “H” level indicating a non-recording state. A stage number signal S5 output from a delay correction calculation circuit 55 has a value of “30”. This stage number signal S5 is fed back to a selector 52 as a stage number control signal S1 by a stage number signal feedback control circuit 56. According to the stage number control signal S1, the selector 52 selectively outputs as a prescribed delay clock signal SCK2i one delay clock signal of a delay clock signal group SCK2 output from a delay line 51.

During the period between time T1 and time T2, first data DATA1 is input as a data signal. In this period, a recording waveform generation circuit 58 processes the first data DATA1 based on the prescribed delay clock signal SCK2i to generate a recording waveform signal SWF. The recording waveform signal SWF thus generated is recorded on a not-shown optical disk. During this recording period, the stage number signal feedback control circuit 56 does not control the selection operation of the selector 52. This is because the recording waveform signal SWF is distorted if the stage number to be selected by the selector 52 is changed during the data-recording period. In other words, even if the value of the stage number signal S5 varies, the resultant value will not be fed back to the selector 52 as a stage number control signal S1.

During the period between time T2 and time T4, data to be recorded is not input as a data signal DATA. During this period, the stage number signal feedback control circuit 56 controls the selection operation of the selector 52. In other words, the delay time of delay elements in the delay line 51 varies due to a temperature change or the like. Even if the value of the stage number signal S5 varies, the resultant value is supplied in real time to the selector 52 as a stage number control signal S1. As a result, a proper prescribed delay clock signal SCK2i can always be obtained. In FIG. 6, at time T3, the value of the stage number control signal S1 increases from “30” to “31” according to a change in the stage number signal S5.

During the period between time T4 and time T5, second data DATA2 is input as a data signal DATA. In this period, the recording waveform generation circuit 58 processes the second data DATA2 based on the prescribed delay clock signal SCK2i to generate a recording waveform signal SFW. Like the period between time T1 and time T2, the stage number signal feedback control signal 56 does not control the selection operation of the selector 52 during this period.

From time T5, data to be recorded is not input as a data signal DATA. Accordingly, the value of the stage number signal S5 is supplied to the selector 52 as a stage number control signal S1. It is assumed in FIG. 6 that the value of the stage number signal S5 changes from “31” to “28” during the period between time T4 and time T5. In other words, at time T5, “28” is fed back to the selector 52 as a stage number control signal S1.

However, the conventional structure has the following problems.

In the conventional structure as shown in FIG. 5, the selection operation of the selector 52 is not controlled during the data-recording period in order to prevent distortion of the recording waveform signal SWF. Accordingly, during the data-recording period, the prescribed delay clock signal SCK2i is not necessarily optimized in phase. Even if the phase of the prescribed delay clock signal SCK2i is set to an optimal value before starting the data recording, the delay time of each delay element in the delay line 51 may vary due to a temperature rise of the optical disk device or the like while the data is continuously recorded for a long time. In such a case, the phase of the prescribed delay clock signal SCK2i may possibly be shifted from the optimal value. This shifts the timing of generating the recording waveform signal, degrading accuracy of the recording waveform signal.

### SUMMARY OF THE INVENTION

It is an object of the present invention to enable a recording waveform signal to be accurately generated in a stable manner in a disk recording device even when data is continuously recorded for a long time.

More specifically, a recording waveform generator according to the present invention includes: a delay line including a plurality of delay elements connected in series with each other, for receiving a first clock signal and outputting respective outputs of the delay elements as a delay clock signal group; a selector for selecting one delay clock signal from the delay clock signal group as a prescribed delay clock signal; a recording waveform generation circuit for receiving a data signal and processing the data signal in synchronization with the prescribed delay clock signal to generate a recording waveform signal; a selection control section for controlling selection operation of the selector according to an applied delay time indication signal; and a mark space detection circuit for receiving the data signal and detecting a space period in the data signal. The selection control section receives a record/non-record signal, controls the selector when the record/non-record signal indicates a non-data-recording state, and controls the selector in response to detection of the space period by the mark space detection circuit when the record/non-record signal indicates a data-recording state.

According to the present invention, the selection operation of the selector for selecting the prescribed delay clock signal is controlled by the selection control section not only when the record/non-record signal indicates a non-data-recording state, but also when the record/non-record signal indicates a data recording state as well as the mark space detection circuit detects a space period. In other words, even when the data is being recorded, the prescribed delay clock signal for use in generation of the recording waveform signal can be optimized in phase during the space period. This enables the recording waveform signal to be accurately generated even when the data is continuously recorded for a long time.

Preferably, the selection control section includes a first means for detecting from the delay clock signal group a clock signal behind the first clock signal by a prescribed time, and obtaining a delay time per delay element in the delay line based on a stage number of the delay element in the delay line that outputs the detected clock signal and the prescribed time, and a second means for obtaining a stage number of the delay element in the delay line to be selected by the selector, based on a delay time indicated by the delay time indication signal and the delay time per delay element obtained by the first means.

A recording waveform generator according to the present invention includes: a phase adjustment section for receiving a first clock signal and, in response to an applied delay time indication signal, adjusting a phase of the first clock signal with a resolution of 360/n degrees (where n is an integer equal to or larger than 2) according to a delay time indicated by the delay time indication signal and outputting the resultant signal as a second clock signal; a delay line including a plurality of delay elements connected in series with each other, for receiving the second clock signal and outputting respective outputs of the delay elements as a delay clock signal group; a selector for selecting one delay clock signal from the delay clock signal group as a prescribed delay clock signal; a recording waveform generation circuit for receiving a data signal and processing the data signal in synchronization with the prescribed delay clock signal to generate a recording waveform signal; and a selection control section for controlling selection operation of the selector according to the delay time indication signal.

According to the present invention, in response to the delay time indication signal, the phase adjustment section roughly adjusts the phase of the first clock signal with a resolution of 360/n degrees for output as the second clock signal. The second clock signal is then applied to the delay line, and the prescribed delay clock signal is selected. Since the phase of the second clock signal has been roughly adjusted according to a desired delay time, the delay time in the delay line can be reduced. This allows for significant reduction in the number of delay elements in the delay line.

Preferably, the recording waveform generator according to the present invention further includes a mark space detection circuit for receiving the data signal and detecting a space period in the data signal. Preferably, the selection control section receives a record/non-record signal, controls the selector when the record/non-record signal indicates a non-data-recording state, and controls the selector in response to detection of the space period by the mark space detection circuit when the record/non-record signal indicates a data-recording state.

Preferably, the phase adjustment section in the recording waveform generator according to the present invention includes a frequency multiplying means for multiplying the first clock signal and outputting a multiplied clock signal having a frequency of the first clock signal multiplied by n, a shifting means for shifting the phase of the first clock signal by using the multiplied clock signal, and outputting a plurality of clock signals having their phases shifted by 360/n degrees from each other, and a selector for selecting one of the plurality of clock signals output from the shifting means according to the delay time indication signal, and outputting the selected clock signal as the second clock signal.

Preferably, the selection control section includes a first means for detecting from the delay clock signal group a clock signal behind the multiplied clock signal by a prescribed time, and obtaining a delay time per delay element in the delay line based on a stage number of the delay element in the delay line that outputs the detected clock signal and the prescribed time, and a second means for obtaining a stage number of the delay element in the delay line to be selected by the selector, based on the delay time indicated by the delay time indication signal and the delay time per delay element obtained by the first means.

A disk recording device according to the present invention includes the recording waveform generator according to the present invention, wherein a recording waveform signal output from the recording waveform generator is recorded on a disk.

### BRIEF DESCRIPTION OF THE DRAWINGS

FIG. 1 is a block diagram showing the structure of a recording waveform generator according to a first embodiment of the present invention;

FIG. 2 is a timing chart illustrating operation of the recording waveform generator in FIG. 1;

FIG. 3 is a block diagram showing the structure of a recording waveform generator according to a second embodiment of the present invention;

FIGS. 4A and 4B illustrate record compensation operation;

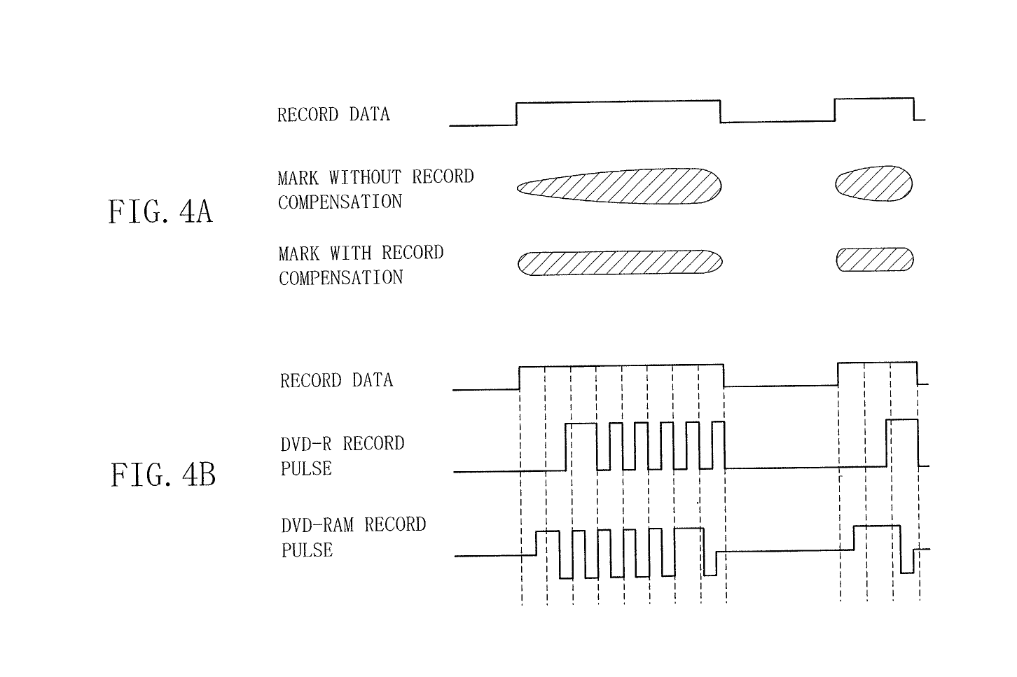

FIG. 5 is a block diagram showing the structure of a conventional recording waveform generator; and

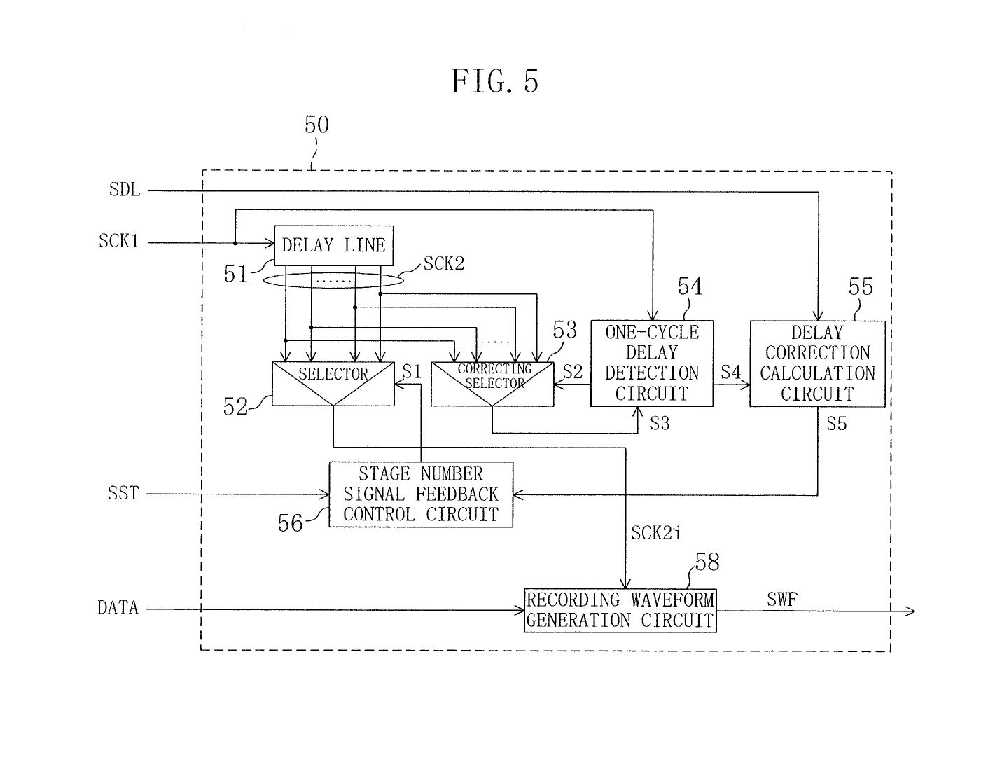

FIG. 6 is a timing chart illustrating operation of the recording waveform generator in FIG. 5.

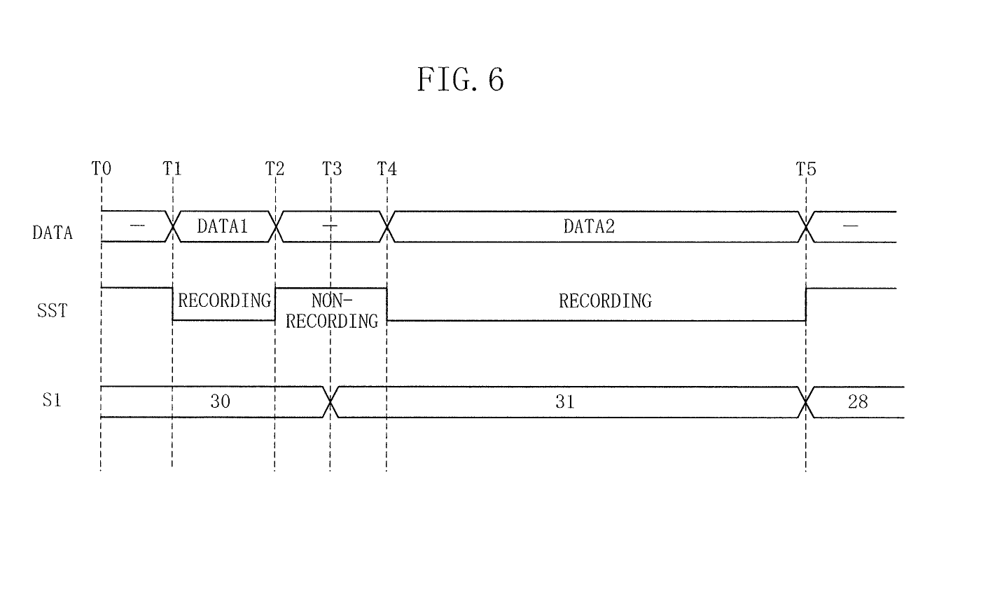

### DETAILED DESCRIPTION OF THE INVENTION

Hereinafter, embodiments of the present invention will be described in conjunction with the accompanying drawings.

(First Embodiment)

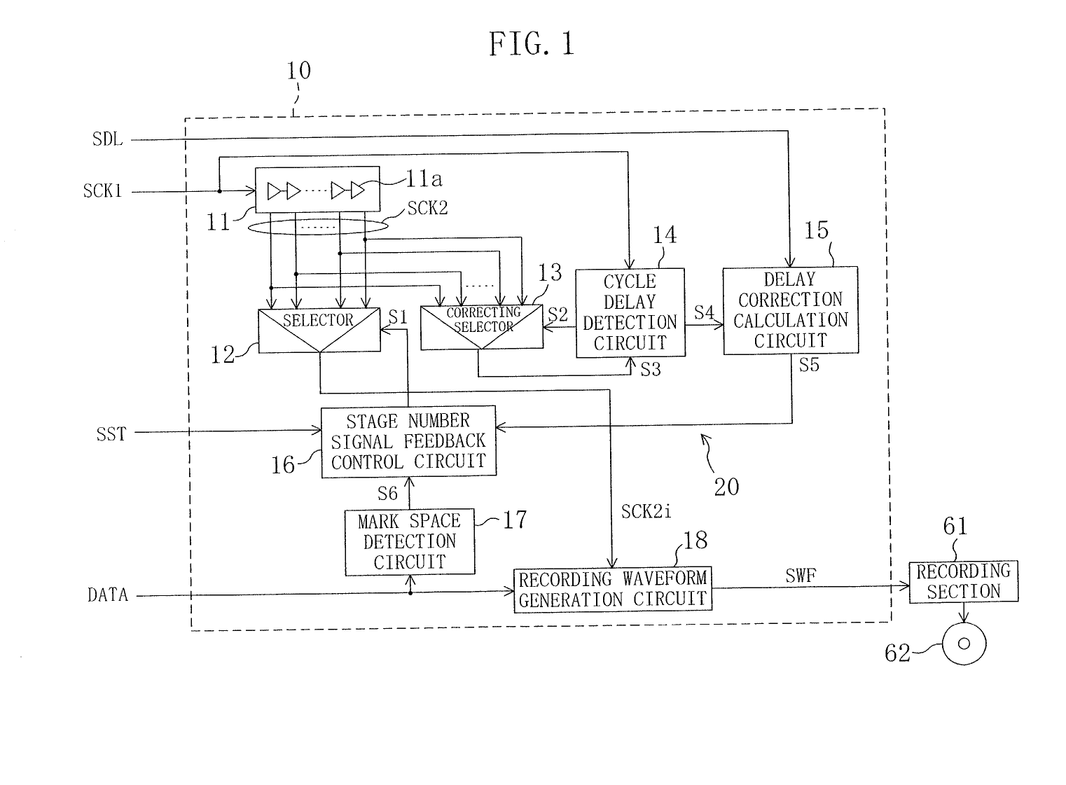

FIG. 1 is a block diagram showing the structure of a recording waveform generator according to the first embodiment of the present invention. The recording waveform generator 10 in FIG. 1 receives a data signal DATA as an input, and processes the data signal DATA in synchronization with a prescribed delay clock signal SCK2i to generate a recording waveform signal SWF. In a disk recording device including the recording waveform generator 10, the recording waveform signal SWF output from the recording waveform generator 10 is recorded on a recording medium such as an optical disk 62 by a recording section 61. Record compensation operation such as that described above is thus implemented.

In addition to the data signal DATA, the recording waveform generator 10 receives as inputs a first clock signal SCK1 serving as a reference clock when the data signal DATA is recorded on the optical disk 62, a delay time indication signal SDL indicating the delay time by which the first clock signal SCK1 is to be delayed, and a record/non-record signal SST indicating whether the data signal DATA is to be recorded or not, that is, a data-recording state or a non-data-recording state.

In FIG. 1, a delay line 11 has a plurality of delay elements 11a connected in series with each other. Each delay element 11a outputs an input signal with a prescribed delay time. The delay line 11 receives the first clock signal SCK1 and outputs the respective outputs of the delay elements 11a as a delay clock signal group SCK2. In other words, the delay clock signal group SCK2 is a set of signals each having a different phase difference from the first clock signal SCK1.

A selector 12 selects one delay clock signal from the delay clock signal group SCK2 output from the delay line 11, and outputs the selected delay clock signal as a prescribed delay clock signal SCK2i. The selection operation of the selector 12 is controlled by a stage number control signal S1 from a selection control section 20 described below.

The selection control section 20 controls the selection operation of the selector 12 according to the applied delay time indication signal SDL. The selection control section 20 includes a correcting selector 13, a cycle delay detection circuit 14, a delay correction calculation circuit 15 and a stage number signal feedback control circuit 16.

The correcting selector 13 selects one delay clock signal from the delay clock signal group SCK2 according to an output signal S2 of the cycle delay detection circuit 14, and outputs the selected delay clock signal as a signal S3. The cycle delay detection circuit 14 conducts phase comparison between the output signal S3 of the correcting selector 13 and the first clock signal SCK1, and feeds back a signal S2 so that the time difference between the signal S3 and the signal SCK1 corresponds to one cycle of the signal SCK1. Thus, the signal S3 finally becomes a clock signal behind the first clock signal SCK1 by a prescribed time corresponding to one cycle thereof.

In addition to the above phase adjustment, the cycle delay detection circuit 14 obtains a delay time per delay element 11a in the delay element 11 for output as a signal S4. For example, when the signal S3 is an output of the delay element 11a of the nth stage, that is, when a delay corresponding to one cycle of the first clock signal SCK1 has been generated by n delay elements, the delay time per delay element 11a is obtained by dividing the time corresponding to one cycle by n. The delay time per delay element 11a varies according to a temperature change. However, even if the delay time varies, the cycle delay detection circuit 14 can always accurately detect the delay time per delay element 11a in the delay line 11. The correcting selector 13 and the cycle delay detection circuit 14 form a first means.

The delay correction calculation circuit 15 receives the delay time indication signal SDL and the output signal S4 of the cycle delay detection circuit 14, and obtains the stage number of the delay element 11a in the delay line 11 that is to be selected by the selector 12 for output as a stage number signal S5. In other words, based on the delay time per delay element 11a indicated by the signal S4, the delay correction calculation circuit 15 determines by calculation the output of the delay signal 11a of which stage in the delay line 11 should be selected in order to obtain the delay time indicated by the delay time indication signal SDL. The delay correction calculation circuit 15 forms a second means.

The stage number signal feedback control circuit 16 receives the stage number signal S5 output from the delay correction calculation circuit 15, the record/non-record signal SST, and a mark space signal S6 output from a mark space detection circuit 17 described below, and controls the selection operation of the selector 12 by the stage number control signal S1. The stage number signal feedback control circuit 16 outputs the stage number signal S5 as a stage number control signal S1 in order to control the selector 12, and otherwise holds the value of the stage number signal S5 therein.

The mark space detection circuit 17 receives a data signal DATA, and detects a space period in the data signal DATA. The term “space period” herein refers to a period during which no mark is recorded when recording the data signal DATA, that is, a period during which a recording waveform need not be generated. More specifically, in many optical disk devices, a period during which the value “0” is recorded as data is a space period. It should be understood that, depending on the relation between a digital value and a mark, there may be a case where a period during which the value “1” is recorded is a space period. The mark space detection circuit 17 outputs a mark space signal S6 that is rendered valid (“H”) in response to detection of the space period.

A recording waveform generation circuit 18 processes the received data signal DATA in synchronization with the prescribed delay clock signal SCK2i supplied from the selector 12 so as to produce a recording waveform signal SWF.

In the case where the record/non-record signal SST indicates a non-data-recording state, the stage number signal feedback control circuit 16 controls the selection operation of the selector 12. In the case where the record/non-record signal SST indicates a data-recording state, the stage number signal feedback control circuit 16 controls the selection operation of the selector 12 in response to a valid mark space signal S6, that is, in response to detection of the space period by the mark space detection circuit 17. The phase of the prescribed delay clock signal SCK2i can thus be optimized in the space period even if the data signal DATA is being recorded. This enables data recording to be conducted more stably as compared to the conventional example even when the data is continuously recorded on the disk 62 for a long time.

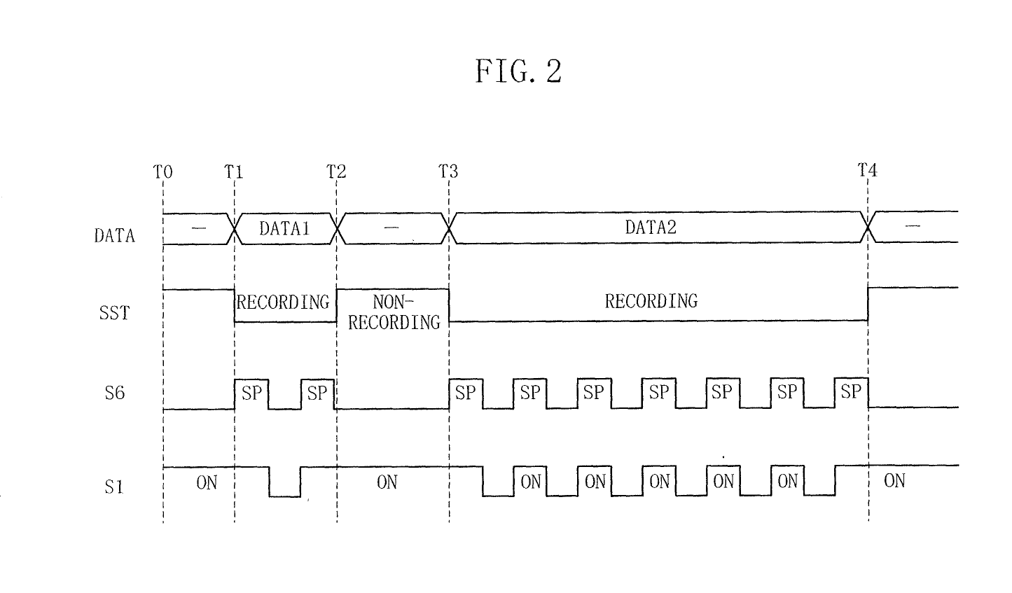

Operation of the recording waveform generator 10 in FIG. 1 will now be described in connection with FIG. 2. FIG. 2 shows a change with time in the external data signal DATA, the external record/non-record signal SST, the mark space signal S6 output from the mark space detection circuit 16, and the stage number control signal S1 output from the stage number signal feedback control circuit 16. Note that, in fact, the stage number control signal S1 designates the stage number of the delay element 11a to be selected by the selector 12. In FIG. 2, however, a period during which the selection operation of the selector 12 is controlled is denoted with “ON” for simplicity. This signal corresponds to a control signal within the stage number signal feedback control circuit 16, and is obtained by OR operation of the record/non-record signal SST and the mark space signal S6.

As shown in FIG. 2, during the period between time T0 and time T1, data to be recorded is not input as a data signal DATA. During this period, the record/non-record signal SST is at “H” level indicating a non-recording state and the stage number control signal S1 is valid, so that the selection operation of the selector 12 is controlled. The mark space signal S6 is invalid, that is, at “L” level.

During the period between time T1 and time T2, first data DATA1 is input as a data signal DATA, and the record/non-record signal SST goes to “L” level indicating a recording state. In this period, the mark space signal S6 becomes valid at the timing shown in the figure. Accordingly, the stage number control signal S1 also becomes valid at the timing shown in the figure. As a result, the selection operation of the selector 12 is controlled in response to detection of the space period (denoted with “SP” in the figure) even when the data is being recorded. In other words, if the stage number signal S5 changes during the space period, the resultant value of the stage number signal S5 is supplied in real time to the selector 12 as a stage number control signal S1. As a result, the prescribed delay clock signal SCK2i output from the selector 12 is optimized in phase, whereby an optimal recording waveform signal SWF is output.

During the period between time T2 and time T3, data to be recorded is not input as a data signal DATA. During this period, the record/non-record signal SST is at “H” level indicating a non-recording state, and the stage number control signal S1 is valid, so that the selection operation of the selector 12 is controlled. The mark space signal S6 is invalid, that is, at “L” level.

During the period between time T3 and time T4, second data DATA2 is input as a data signal DATA, and the record/non-record signal SST goes to “L” level indicating a recording state. In this period, the mark space signal S6 becomes valid at the timing shown in the figure. Accordingly, the stage number control signal S1 also becomes valid at the timing shown in the figure. If the stage number signal S5 changes during this period, the resultant value of the stage number signal S5 is supplied in real time to the selector 12 as a stage number control signal S1. As a result, the phase of the prescribed delay clock signal SCK2i output from the selector 12 is optimized, whereby an optimal recording waveform signal SWF is output.

Note that, although the period between time T3 and time T4 is quite longer than that between time T1 and time T2, an optimal recording waveform can be obtained by controlling the selection operation of the selector 12 also during the space period.

As has been described above, according to the present embodiment, not only when the data is not being recorded on the disk but also when the data is being recorded thereon, a clock signal serving as a reference for data recording can be optimized in phase during the space period (e.g., a period during which the data to be recorded is “0”). This enables a recording waveform signal to be generated stably even when the data is continuously recorded for a long time.

(Second Embodiment)

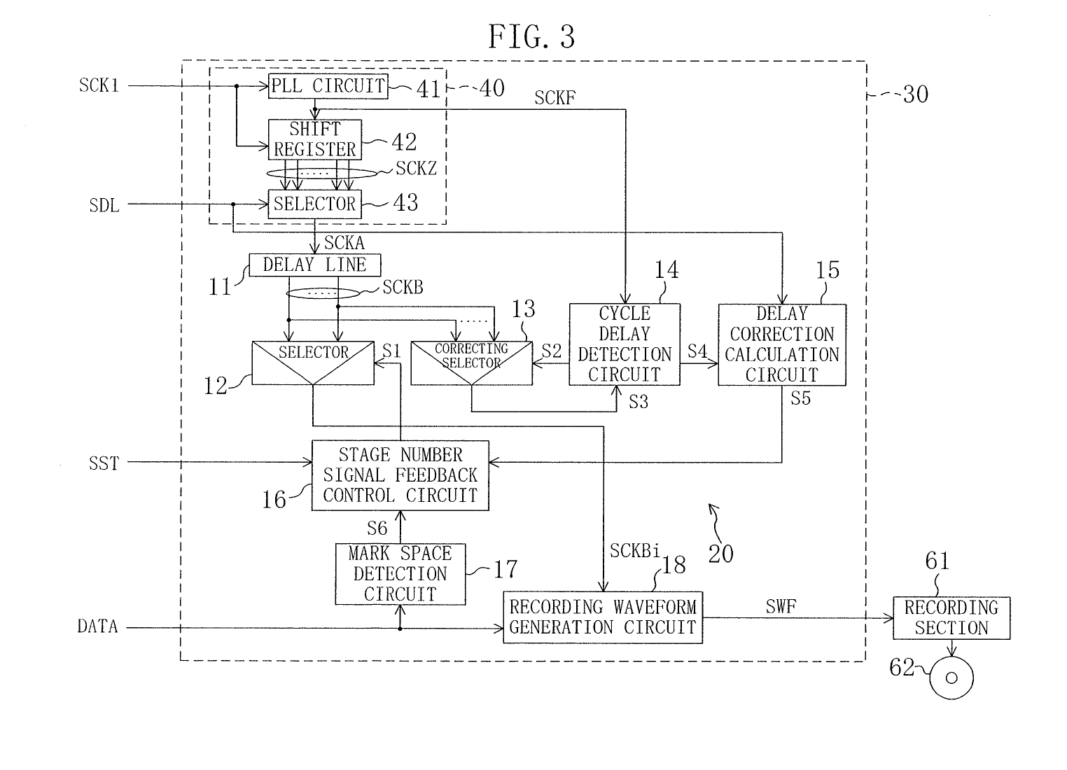

FIG. 3 is a block diagram showing the structure of a recording waveform generator according to the second embodiment of the present invention. In FIG. 3, the components common to FIG. 1 are denoted with the same reference numerals and characters as those of FIG. 1.

The recording waveform generator 30 shown in FIG. 3 is the same as the recording waveform generator 10 of the first embodiment shown in FIG. 1 in terms of the input and output. The recording waveform generator 30 in FIG. 3 is different from that of FIG. 1 in that an applied first clock signal SCK1 is roughly adjusted in phase in a phase adjustment section 40, and a prescribed delay clock signal SCKBi is generated based on a second clock signal SCKA resulting from the phase adjustment.

The phase adjustment section 40 includes a PLL (Phase Locked Loop) circuit 41, a shift register 42 and a selector 43. The phase adjustment section 40 adjusts the phase of the first clock signal SCK1 with a resolution of 360/n degrees (where n is an integer equal to or larger than 2) according to a delay time indication signal SDL, and outputs the resultant signal as a second clock signal SCKA. The PLL circuit 41 serving as a frequency multiplying means multiplies the first clock signal SCK1 by n and outputs a multiplied clock signal SCKF having a frequency of the first clock signal SCK1 multiplied by n. The shift register 42 serving as a shifting means shifts the phase of the first clock signal SCK1 by using the multiplied clock signal SCKF, and outputs a plurality of clock signals SCKZ having their phases shifted by 360/n degrees from each other.

The selector 43 selects one of the plurality of clock signals SCKZ according to the delay time indication signal SDL, and outputs a second clock signal SCKA. The clock signal selected by the selector 43 is a clock signal that may have the delay time indicated by the delay time indication signal SDL behind the first clock signal SCK1 when the delay time in the delay line 11 is applied to that clock signal. In the structure of FIG. 1, the time difference between the first clock signal SCK1 and the delay clock signal group SCK2 is obtained only by the delay time in the delay line 11.

The delay line 11, the selector 12 and the selection control section 20 finely adjust the phase of the second clock signal SCKA output from the phase adjustment section 40 with a resolution corresponding to the delay time per delay element 11a of the delay line 11.

The delay line 11 receives the second clock signal SCKA, and outputs the respective outputs of the delay elements 11a as a delay clock signal group SCKB. In other words, the delay clock signal group SCKB is a set of signals each having a different phase difference from the second clock signal SCKA.

Since the phase of the second clock signal SCKA has already been adjusted by the phase adjustment section 40 with a resolution of 360/n degrees, the delay time to be generated by the delay line 11 is only 1/n of that of the first embodiment. The number of delay elements 11a in the delay line 11 is therefore 1/n of that of the structure in FIG. 1.

The selector 12 selects one delay clock signal from the delay clock signal group SCKB output from the delay line 11 as a prescribed delay clock signal SCKBi. The selection operation of the selector 12 is controlled by a stage number control signal S1 from the selection control section 20.

In the selection control section 20, the correcting selector 13 selects one delay clock signal from the delay clock signal group SCKB according to an output signal S2 of the cycle delay detection circuit 14, and outputs the selected delay clock signal as a signal S3. The cycle delay detection circuit 14 conducts phase comparison between the output signal S3 of the correcting selector 13 and the multiplied clock signal SCKF output from the phase adjustment section 40, and feeds back a signal S2 so that the time difference between the signal S3 and the signal SCKF corresponds to one cycle of the signal SCKF. Thus, the signal S3 finally becomes a clock signal behind the multiplied clock signal SCKF by a prescribed time corresponding to one cycle thereof.

In addition to the above phase adjustment, the cycle delay detection circuit 14 obtains a delay time per delay element 11a in the delay element 11 for output as a signal S4. For example, when the signal S3 is an output of the delay element 11a of the mth stage, that is, when a delay corresponding to one cycle of the multiplied clock signal SCKF has been generated by m delay elements, the delay time per delay element 11a is obtained by dividing the time corresponding to one cycle (1/n of the cycle of the first clock signal SCK1) by m.

The delay correction calculation circuit 15 receives the delay time indication signal SDL and the output signal S4 of the cycle delay detection circuit 14, and obtains the stage number of the delay element 11a in the delay line 11 that is to be selected by the selector 12 for output as a stage number signal S5.

Operation of the stage number signal feedback control circuit 16, the mark space detection circuit 17 and the recording waveform generation circuit 18 is the same as that of the first embodiment.

Operation of the recording waveform generator in FIG. 3 will now be described.

When the first clock signal SCK1 is input, the PLL circuit 41 in the phase adjustment section 40 generates a multiplied clock signal SCKF having a frequency of the signal SCK1 multiplied by n. The multiplied clock signal SCKF thus generated is supplied to the shift register 42. The shift register 42 shifts the phase of the first clock signal SCK1 by using the multiplied clock signal SCKF, and thus generates a plurality of clock signals SCKZ having their phases shifted by 360/n degrees from each other.

The selector 43 selects one of the plurality of clock signals SCKZ output from the shift register 42 according to the delay time indication signal SDL, and outputs the selected clock signal as a second clock signal SCKA. The second clock signal SCKA is a clock signal that may have the delay time indicated by the delay time indication signal SDL behind the first clock signal SCK1 when the delay time in the delay line 11 is applied.

The second clock signal SCKA output from the phase adjustment section 40 is applied to the delay line 11. The following operation is the same as that of the first embodiment.

More specifically, according to the present embodiment, the phase adjustment section 40 roughly adjusts the phase of the first clock signal SCK1 with a resolution of 360/n degrees for output as the second clock signal SCKA. Therefore, the time corresponding to 360/n degrees of the phase of the first clock signal SCK1 is enough as the delay time in the delay line 11. This enables the number of delay element 11a in the delay line 11 to be reduced to 1/n of that of the first embodiment, allowing for significant reduction in circuit scale.

The same effects as those of the first embodiment can also be obtained. More specifically, not only when the data is not being recorded on the disk but also when the data is being recorded thereon, a clock signal serving as a reference for data recording can be optimized in phase during the space period (e.g., a period during which the data to be recorded is “0”). This enables a recording waveform signal to be generated stably even when the data is continuously recorded for a long time.

It should be understood that the above effects can also be obtained even if the mark space detection circuit 17 is not provided in the present embodiment.

Note that, in each of the above embodiments, the recording waveform signal SWF generated is recorded on the optical disk 62. However, the present invention is also applicable to the case where the recording waveform signal SWF is recorded on another recording medium. For example, even when the recording waveform signal SWF is recorded on a hard disk, the same control as that of the record compensation operation for the optical disk is required. Therefore, the present invention is effective in such a case.

As has been described above, according to the present invention, even when the data is being recorded, the prescribed delay clock signal serving as a reference for data recording is optimized in phase during the space period. This enables a recording waveform signal to be accurately generated in a stable manner even when the data is continuously recorded for a long time. Moreover, the number of delay elements in the delay line can be significantly reduced, allowing for significant reduction in circuit scale.

What is claimed is:

1. A recording waveform generator, comprising:
a delay line including a plurality of delay elements connected in series with each other, for receiving a first clock signal and outputting respective outputs of the delay elements as a delay clock signal group;
a selector for selecting one delay clock signal from the delay clock signal group as a prescribed delay clock signal;
a recording waveform generation circuit for receiving a data signal and processing the data signal in synchronization with the prescribed delay clock signal to generate a recording waveform signal;
a selection control section for controlling selection operation of the selector according to an applied delay time indication signal; and
a mark space detection circuit for receiving the data signal and detecting a space period in the data signal,
wherein the selection control section receives a record/non-record signal, controls the selector when the record/non-record signal indicates a non-data-recording state, and controls the selector in response to detection of the space period by the mark space detection circuit when the record/non-record signal indicates a data-recording state.

2. The recording waveform generator according to claim 1, wherein the selection control section includes
a first means for detecting from the delay clock signal group a clock signal behind the first clock signal by a prescribed time, and obtaining a delay time per delay element in the delay line based on a stage number of the delay element in the delay line that outputs the detected clock signal and the prescribed time, and
a second means for obtaining a stage number of the delay element in the delay line to be selected by the selector, based on a delay time indicated by the delay time indication signal and the delay time per delay element obtained by the first means.

3. A recording waveform generator, comprising:
a phase adjustment section for receiving a first clock signal and, in response to a delay time indication signal, adjusting a phase of the first clock signal with a resolution of 360/n degrees (where n is an integer equal to or larger than 2) according to a delay time indicated by the delay time indication signal and outputting the resultant signal as a second clock signal;
a delay line including a plurality of delay elements connected in series with each other, for receiving the second clock signal and outputting respective outputs of the delay elements as a delay clock signal group;
a selector for selecting one delay clock signal from the delay clock signal group as a prescribed delay clock signal;
a recording waveform generation circuit for receiving a data signal and processing the data signal in synchronization with the prescribed delay clock signal to generate a recording waveform signal; and
a selection control section for controlling selection operation of the selector according to the delay time indication signal.

4. The recording waveform generator according to claim 3, further comprising a mark space detection circuit for receiving the data signal and detecting a space period in the data signal, wherein the selection control section receives a record/non-record signal, controls the selector when the record/non-record signal indicates a non-data-recording state, and controls the selector in response to detection of the space period by the mark space detection circuit when the record/non-record signal indicates a data-recording state.

5. The recording waveform generator according to claim 3, wherein the phase adjustment section includes
a frequency multiplying means for multiplying the first clock signal and outputting a multiplied clock signal having a frequency of the first clock signal multiplied by n,
a shifting means for shifting the phase of the first clock signal by using the multiplied clock signal, and outputting a plurality of clock signals having their phases shifted by 360/n degrees from each other, and
a selector for selecting one of the plurality of clock signals output from the shifting means according to the delay time indication signal, and outputting the selected clock signal as the second clock signal.

6. The recording waveform generator according to claim 5, wherein the selection control section includes
a first means for detecting from the delay clock signal group a clock signal behind the multiplied clock signal by a prescribed time, and obtaining a delay time per delay element in the delay line based on a stage number of the delay element in the delay line that outputs the detected clock signal and the prescribed time, and
a second means for obtaining a stage number of the delay element in the delay line to be selected by the selector, based on the delay time indicated by the delay time indication signal and the delay time per delay element obtained by the first means.

7. A disk recording device, comprising the recording waveform generator according to claim 1, wherein a recording waveform signal output from the recording waveform generator is recorded on a disk.

8. A disk recording device, comprising the recording waveform generator according to claim 3, wherein a recording waveform signal output from the recording waveform generator is recorded on a disk.
